(19) United States
(12) Patent Application Publication
(10) Pub. No.: US 2016/0259327 A1
(43) Pub. Date: Sep. 8, 2016

(54) CONTROL DEVICE CAPABLE OF CENTRALLY MANAGING CONTROL BY GROUPING A PLURALITY OF SYSTEMS

(71) Applicant: FANUC Corporation, Yamanashi (JP)

(72) Inventor: Yuuki OONISHI, Yamanashi (JP)

(21) Appl. No.: 15/057,435

(22) Filed: Mar. 1, 2016

(30) Foreign Application Priority Data
Mar. 2, 2015 (JP) 2015-040496

(51) Int. Cl. G05B 19/4155

(52) U.S. Cl. CPC G05B 19/4155; G05B 2219/40007

(57) ABSTRACT

A control device selects two systems or more from a plurality of systems based on a parameter setting of a system group setting unit to set the systems as a system group, selects one system in the system group as a master system to be a reference of operation based on a parameter setting of a master system selection unit, classifies other systems in the system group as a slave system group, and controls the operation of the slave system group so as to be synchronized with the operation of the master system by referring to a program command, a control signal, and a control parameter stored in a control information storage unit as master control information.

### RELATED APPLICATIONS

The present application claims priority to Japanese Patent Application Number 2015-040496, filed Mar. 2, 2015, the disclosure of which is hereby incorporated by reference herein in its entirety.

### BACKGROUND OF THE INVENTION

1. Field of the Invention

The present invention relates to a control device, and in particular, relates to a control device capable of centrally managing control by grouping a plurality of systems.

2. Description of the Related Art

FIG. 18 is a diagram illustrating a system constituted from a belt conveyor and a plurality of imprinters. The system includes a belt conveyor 10, a first imprinter 11, a second imprinter 12, and a control device (not shown) that controls the belt conveyor 10, the first imprinter 11, the second imprinter 12. The system imprints on a target 20 conveyed by the belt conveyor 10 in a moving direction 21 in a predetermined position. The running pace of the whole system depends on the belt conveyor 10 and each of the imprinters 11, 12 responds by operating in the allocated timing.

If the whole system is controlled by one system or one sequence program, when the belt conveyor 10 instructs to set the pace of the whole system to 50%, each of the imprinters 11, 12 performs the respective operation at the pace of 50% so that the timings of the belt conveyor 10 and the imprinters 11, 12 are not disturbed.

Japanese Patent No. 3893334 discloses a multi-system numerical controller that controls a machine tool that performs a plurality of pieces of machining or other work such as turning, milling, and loader control by one unit. As disclosed in Japanese Patent No. 3893334, when different types of control are performed at the same time, a technique of dividing a system into a plurality of systems and independently performing each system concurrently has been used. In addition, a more general-purpose system has been constructed by normally allowing each system to operate independently, but by performing a cooperative operation between systems when necessary.

In the system shown in FIG. 18, the independence of each device is lost by the whole system being controlled by one system and even if a change of the system configuration or machining content is partial, it is necessary to rework the control of the whole sequence program, resulting in a lot of labor.

If the system is controlled by a plurality of systems or a plurality of sequence programs, the independence of each device is maintained and a partial change of the system configuration or machining content can flexibly be handled by reworking only a necessary portion of the control. However, due to the control by the plurality of systems, it is necessary to construct the plurality of sequence programs such that when the pace of a belt conveyor is changed to 50%, the sequence programs cooperate to change the pace of each imprinter to 50% following the change of the belt conveyor, resulting in a lot of labor for the construction.

When a cooperative operation between the plurality of systems is implemented, as described above, it is necessary to cause sequence programs controlling the systems to cooperate, but the degree of difficulty of constructing cooperative sequence programs is high. In addition, when the system configuration is changed, sequence programs that cooperate need to be reworked and thus, each time the system configuration is changed, a lot of time is needed for the work.

### SUMMARY OF THE INVENTION

An object of the present invention is to provide a control device capable of controlling a plurality of slave systems by controlling a master system to make the cooperation between systems easier and also capable of flexibly dealing with a change of the system configuration without changing a sequence program of the slave system characterized in that a slave system group is operated in cooperation with the master system.

A control device according to the present invention including a plurality of command analysis units that control a machine having a plurality of axes driven by a motor, a plurality of command execution units that execute a command analyzed by the command analysis units, and a system setting unit that sets by dividing the plurality of axes into a plurality of systems, wherein one axis or a plurality of axes controlled by one program of the plurality of axes is set as one system, to control the plurality of systems includes a system group setting unit that sets two systems or more selected from the plurality of systems as one system group based on a parameter setting, a master system selection unit that selects one system from the system group as a master system to be a reference of operation and classifies other systems of the system group as a slave system group based on a parameter setting, a control information storage unit that stores the program needed for control of the master system and control data including a signal and a parameter related to the control of the program as master control information, and a synchronization unit that controls the operation of the slave system group so as to be synchronized with the operation of the master system by referring to a master control information.

The system group setting unit may be a unit that sets or changes the system group in any timing based on signal control or the command of the program.

The master system selection unit may be a unit that sets or changes the master system in any timing based on the signal control or the command of the program.

The master system selection unit may form a master-slave hierarchical multiple structure by selecting the master system from a plurality of the master systems.

Due to the configuration of the present invention, the slave system group of the system group operates by referring to stored master system information so that the control of the slave system belonging to the same system group as the master system is synchronized, which makes the synchronization between systems easier. Also, when the system configuration is changed such as increasing or decreasing the number of systems or replacing the master system, a control device that can easily be applied by changing system group and master system settings and resetting the group of systems to be synchronized can be provided.

### BRIEF DESCRIPTION OF THE DRAWINGS

The above and other objects and features of the present invention will be apparent from the description of embodiments below with reference to appended drawings. Among these drawings:

FIG. 1 is a diagram illustrating a system constituted from a belt conveyor and three imprinters;

FIG. 2 is a diagram illustrating an example of system control that can implement a synchronizing speed change in the system shown in FIG. 1, but requires a lot of time and effort to create sequence programs;

FIG. 3 is a diagram illustrating implementability of a synchronizing speed change of three imprinters as a slave system group in the system shown in FIG. 1 for a speed change by a sequence program of a belt conveyor as a master system;

FIG. 4 is a diagram illustrating settings of a system group and the master system;

FIG. 5 is a diagram illustrating a system group configuration;

FIG. 6 is a diagram illustrating control of a conventional system;

FIG. 7 is a diagram illustrating control of a system according to the present invention;

FIG. 8A and FIG. 8B are diagrams illustrating before and after a machine configuration change;

FIG. 9 is a diagram illustrating settings of a group number of the system group;

FIG. 10 is a diagram illustrating how settings of the system group are made by a program;

FIG. 11A and FIG. 11B are diagrams illustrating before and after a master change;

FIG. 12 is a diagram illustrating how a plurality of system groups is integrated into one system group;

FIG. 13 is a diagram illustrating an original system group 1;

FIG. 14 is a diagram illustrating an original system group 2;

FIG. 15 is a diagram illustrating a new system group;

FIG. 16 is a functional block diagram of a control device according to the present invention;

FIG. 17 is a diagram illustrating the flow of control; and

FIG. 18 is a diagram illustrating a system constituted from a belt conveyor and two imprinters.

### DETAILED DESCRIPTION OF THE PREFERRED EMBODIMENTS

A control device in the present invention integrates a plurality of systems as a system group based on parameter settings, signal control, or commands of a program or the like and sets one system of the plurality of systems as a master system and other systems as slave systems. Then, in the slave systems, based on program commands executed by the master system, control signals by the sequence program of the master system, or information of control parameters and the like set to the master system, control to synchronize operations of the slave systems based on program commands of the slave systems with the operation of the master system is performed.

By providing such a configuration, when the control, for example, an override is performed on the master system, the slave systems refer to and analyze an override signal input into the master system and control parameters set to the master system and perform control to synchronize the operations of the slave systems with the operation of the master system and thus, in contrast to conventional technology, there is no need to change the sequence program of the slave systems or to input a control signal for the purpose of cooperating with the master and many other systems can centrally be controlled by changing only control data of the master system.

Hereinafter, embodiments of the present invention will be described together with the drawings. The same or similar components to those in the description of conventional technology will be described using the same reference signs.

### First Embodiment

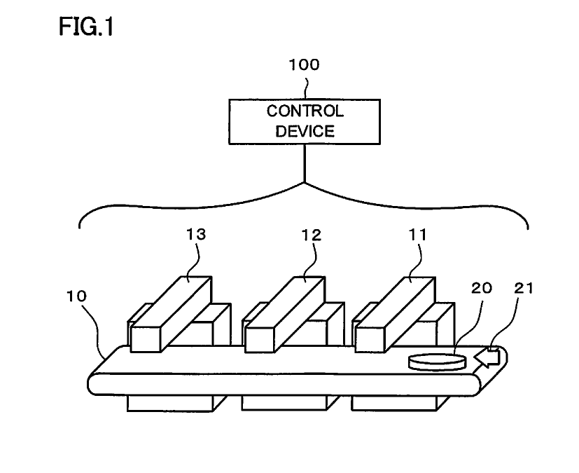

The system constituted from a belt conveyor and three imprinters shown in FIG. 1 is taken as an example. The system includes the belt conveyor 10, the first imprinter 11, the second imprinter 12, a third imprinter 13, and a control device 100 that controls the belt conveyor 10, the first imprinter 11, the second imprinter 12, and the third imprinter 13.

If, for example, the speed of the belt conveyor 10 changes in any timing, the three imprinters 11, 12, 13 also need to change the speed in synchronization with the belt conveyor 10 and if the synchronization is not implemented, imprinting in wrong positions occurs.

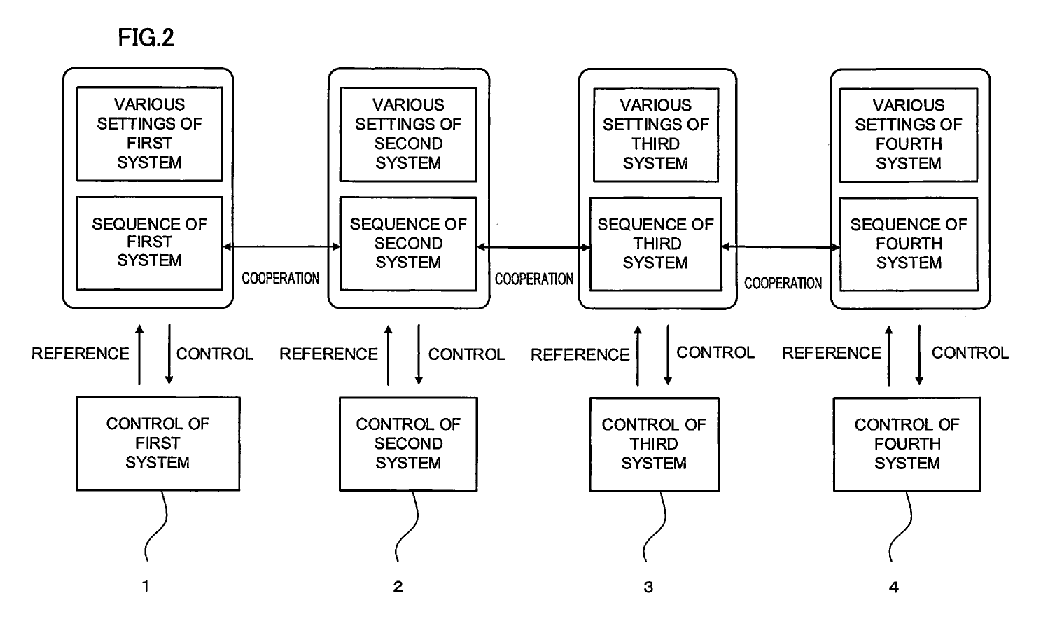

If, as shown in FIG. 2, control 1 of a first system is set to the control of the belt conveyor 10 and controls 2, 3, 4 of second to fourth systems is set to the control of the imprinters 11, 12, 13 respectively, a synchronizing speed change can be implemented by creating a sequence program that provides various settings and inter-system cooperation, but it is necessary to correct the sequence program of each system to allow the belt conveyor as a reference to cooperate with each of the three imprinters, which requires a lot of time and effort.

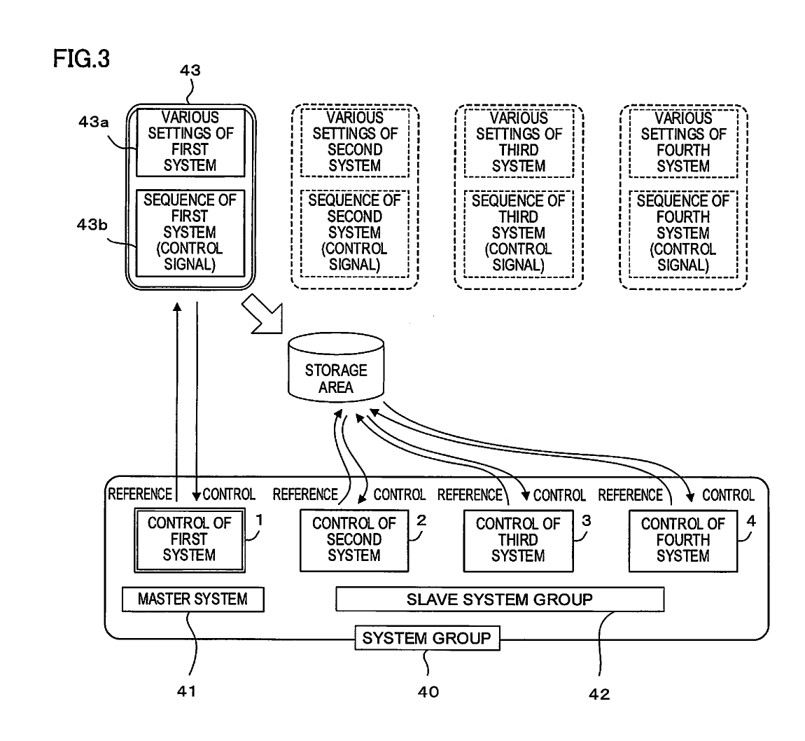

Thus, using a method according to the present invention, first to fourth systems are set as a system group and the first system from the group is set as a master system. FIG. 3 is a diagram illustrating implementability of a synchronizing speed change of the three imprinters 11, 12, 13 as a slave system group 42 in the system shown in FIG. 1 when the speed of the belt conveyor 10 as a master system 41 is changed by the sequence program.

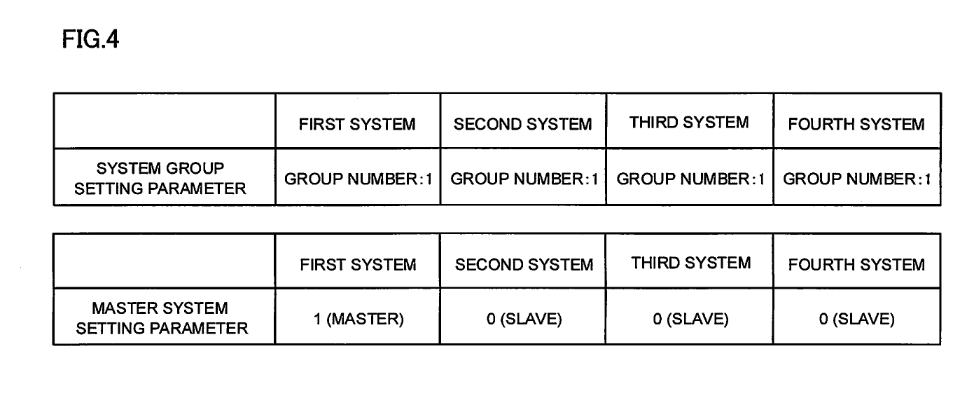

The system group setting and the master system setting are implemented by parameters. To which system group each system belongs is set to the system group setting parameter using a group number. 1 is set to the master system setting parameter for the system to be the master system and 0 for other slave systems. As an example, settings as shown in FIG. 4 are made to set systems 1 to 4 as the same system group (group number 1) in the configuration of FIG. 3 and to set the first system in the group as the master system.

When the method according to the present invention is used, the controls 2, 3, 4 of the second to fourth systems set as the slave system group 42 is performed by referring to a master control information storage area in which various settings (reference sign 43a) of the first system as the master system 41 and data of sequences (reference sign 43b) of the first system are stored. Accordingly, a system group 40 as a whole can centrally be managed by the various settings 43a of the first system and the sequences 43b of the first system and when the speed of the belt conveyor 10 as the master system 41 is changed by the sequence program, a synchronized speed change of the three imprinters 11, 12, 13 as the slave system group 42 can easily be implemented.

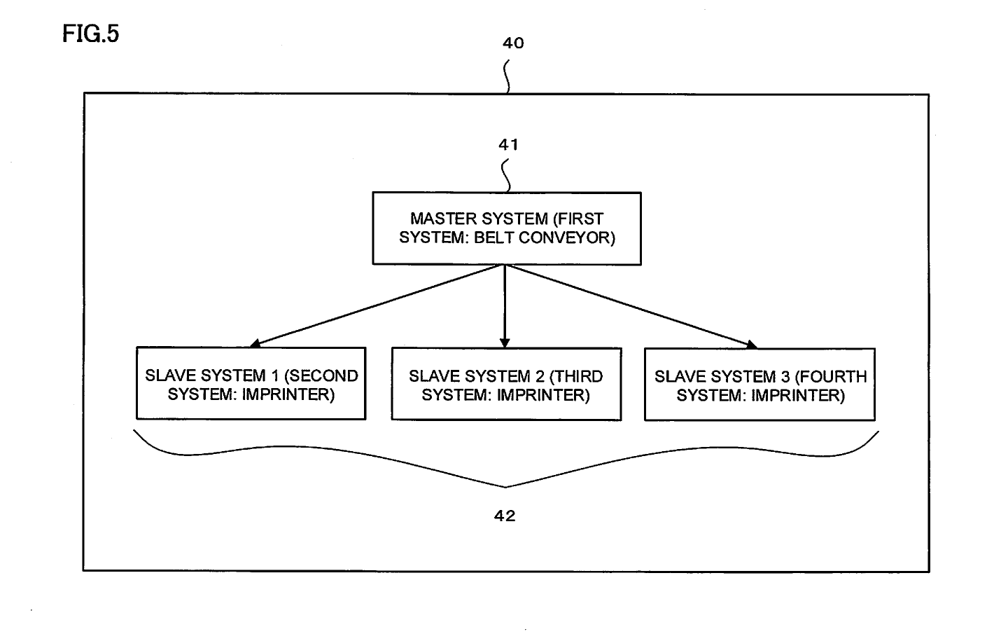

FIG. 5 is a diagram illustrating the configuration of a system group. In the system group 40, the master system 41 is the belt conveyor 10 of the first system, a slave system (1) is the first imprinter 11 of the second system, which constitutes the slave system group 42, a slave system (2) is the second imprinter 12 of the third system, and a slave system (3) is the third imprinter 13 of the fourth system. By adopting the above configuration, the slave systems operate in synchronization by referring to a speed change of the first system as the master system.

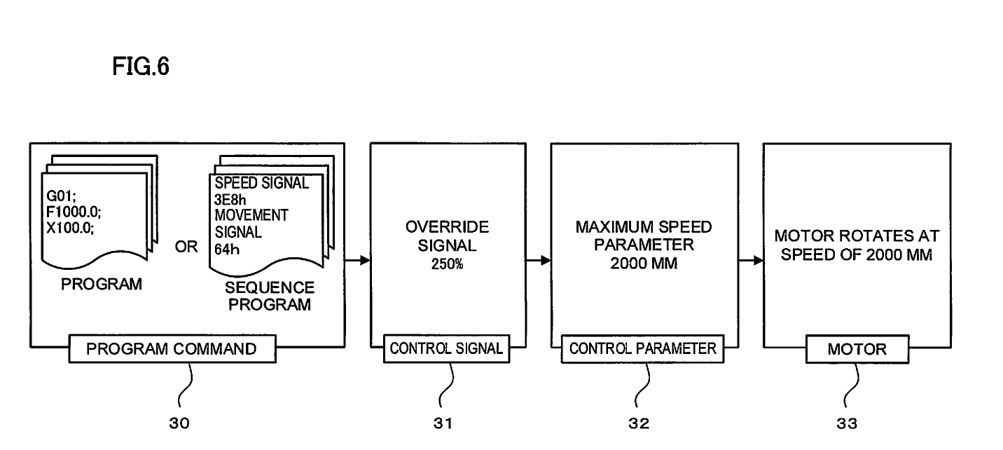

FIG. 6 is a diagram illustrating conventional control of a system. Conventionally, the final rotation of a motor 33 is controlled by starting with a program command (program: a text format program or a sequence program) 30 in each system and then by a control signal 31 and a control parameter 32.

### Example

If the setting of an override control signal that changes the speed to 250% for execution and the setting of a parameter that limits the maximum speed to 2000 mm/min exist for a program command of moving an axis at 1000 mm/min, an operation of moving the axis at 2000 mm/min is obtained as a result of analyzing the settings.

In the case of the example shown in FIG. 6, the input/change/limitation/output described below is performed.

Program command analysis: Speed command of 1000 mm/min is input
→Control signal analysis: Speed command is changed to 2500 mm/min
→Control parameter analysis: Speed command is limited to 2000 mm/min
→Final output: Motor is rotated at 2000 mm/min

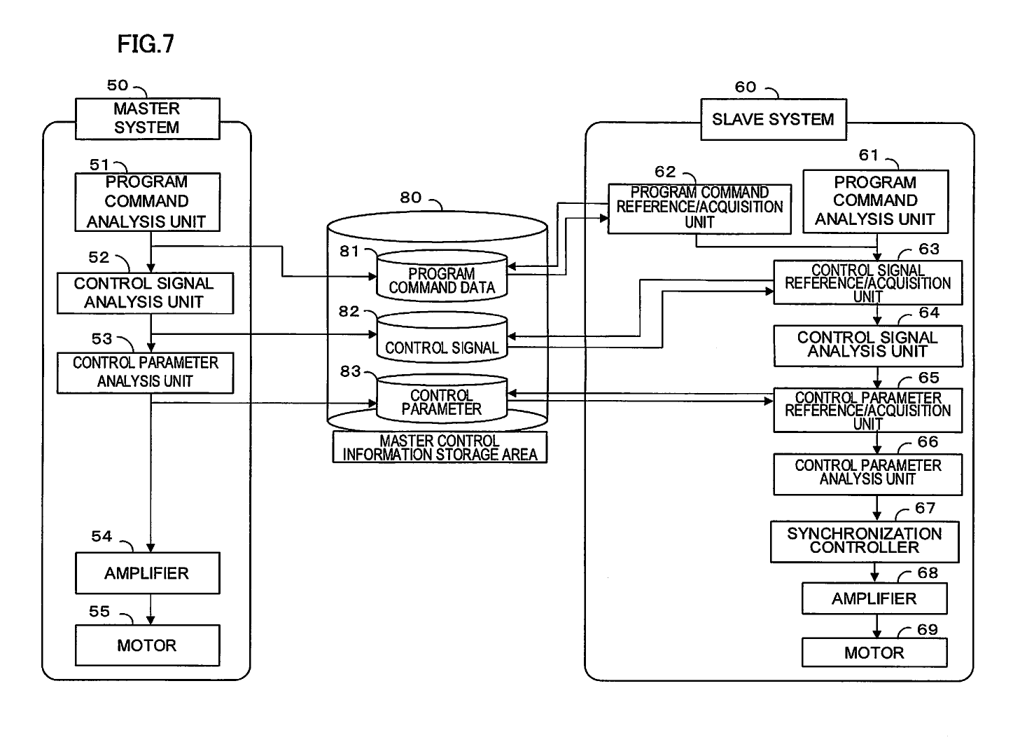

FIG. 7 is a diagram illustrating control of a system according to the present invention. The system control is performed by a control device that controls machine tools and industrial machines. In the present invention, as a concrete implementation method of a mode in which a slave system group operates following a master system in a system group, a master system 50 in the system group stores control information to control the master system in a master control information storage area 80 and a slave system 60 in a slave system group of the system group controls the local system based on control information of the master system 50 by referring to the control information of the master system 50 stored in the master control information storage area 80 and a program of the local system (slave system).

More specifically, the master system 50 includes a program command analysis unit 51, a control signal analysis unit 52, and a control parameter analysis unit 53.

The program command analysis unit 51 reads and analyzes a program (in the example of FIG. 5, an NC program that controls the belt conveyor 10 or the like) for the master system 50 stored in a memory (not shown) and creates program command data showing command content of the program.

The control signal analysis unit 52 analyzes a control signal input into the master system by a sequence program and changes the program command data created by the program command analysis unit 51 based on the control signal. If, for example, an override control signal that changes the speed to 250% for execution is input, the feed speed commanded by the program command data is changed to 2.5 times (250%).

The control parameter analysis unit 53 further changes or limits the program command data changed by the control signal analysis unit 52 based on control parameters set to the master system. If, for example, the parameter setting that limits the maximum speed of an axis of the master system to 2000 mm/min exists and the feed speed commanded by the command data changed by the control signal analysis unit 52 exceeds 2000 mm/min, the feed speed is clamped to 2000 mm/min.

Then, a motor 55 is controlled to be driven via an amplifier 54 based on the program command data generated by the program command analysis unit 51, the control signal analysis unit 52, and the control parameter analysis unit 53. In the master system 50, the program command data output by the program command analysis unit 51, the control signal analyzed by the control signal analysis unit 52, and the control parameter analyzed by the control parameter analysis unit 53 are stored in the master control information storage area 80 (program command data 81, a control signal 82, and a control parameter 83).

On the other hand, the slave system 60 includes a program command analysis unit 61, a program command reference/acquisition unit 62, a control signal reference/acquisition unit 63, a control signal analysis unit 64, a control parameter reference/acquisition unit 65, a control parameter analysis unit 66, and a synchronization controller 67.

The program command analysis unit 61 reads and analyzes a program (in the example of FIG. 4, an NC program that controls the first imprinter 11 or the like) for the slave system 60 stored in a memory (not shown) and creates program command data showing command content of the program.

The program command reference/acquisition unit 62 refers to the master control information storage area 80 and, if program command data of the master system 50 is stored, acquires the program command data 81 of the master system 50.

The control signal reference/acquisition unit 63 refers to the master control information storage area 80 and, if any control signal of the master system 50 is stored, acquires the control signal 82 of the master system 50.

The control signal analysis unit 64 analyzes the control signal 82 of the master system 50 acquired by the control signal reference/acquisition unit 63 and based on an analysis result, changes the program command data 81 of the master system 50 acquired by the program command reference/acquisition unit 62 based on the control signal of the master system 50.

The control parameter reference/acquisition unit 65 refers to the master control information storage area 80 and, if any control parameter of the master system 50 is stored, acquires the control parameter 83 of the master system 50.

The control parameter analysis unit 66 analyzes the control parameter 83 of the master system 50 acquired by the control parameter reference/acquisition unit 65 and based on the control parameter 83 set to the master system, further changes or limits the program command data 81 of the master system 50 changed by the control signal analysis unit 64.

The synchronization controller 67 analyzes how the program command data changes under the control of the control signal and control parameter in the master system 50 based on the program command data of the master system 50 acquired by the program command reference/acquisition unit 62 and the program command data of the master system 50 after changes, limitations or the like obtained as a result of analyses by the control signal analysis unit 64 and the control parameter analysis unit 66 being applied and based on the analysis result, changes the program command data generated by the program command analysis unit 61 so as to be synchronized with the program command data of the master system 50 to drive a motor 69 via an amplifier 68 based on the changed program command data. If, for example, a speed command is issued like the example shown in FIG. 6 in the master system 50, the master system 50 operates, based on the setting of an override control signal and the setting of a parameter, at 2000 mm/min, that is, twice the speed of 1000 mm/min of the program command. The synchronization controller 67 analyzes and finds that the axis is driven twice the speed in the master system 50 based on the program command data of the master system 50 acquired by the program command reference/acquisition unit 62 and the program command data of the master system 50 after changes, limitations or the like obtained as a result of analysis by each analysis unit being applied and changes the feed speed of the axis in the program command data of the slave system 60 to twice the speed so as to be synchronized with the master system 50 to drive the motor 69 via the amplifier 68 based on the changed program command data.

### Second Embodiment

Incidentally, the machine configuration may be changed depending on the usage of machines. For example, the machine configuration shown in the first embodiment described above includes three imprinters, but the number of needed imprinters may increase or decrease due to a change of the target or the like.

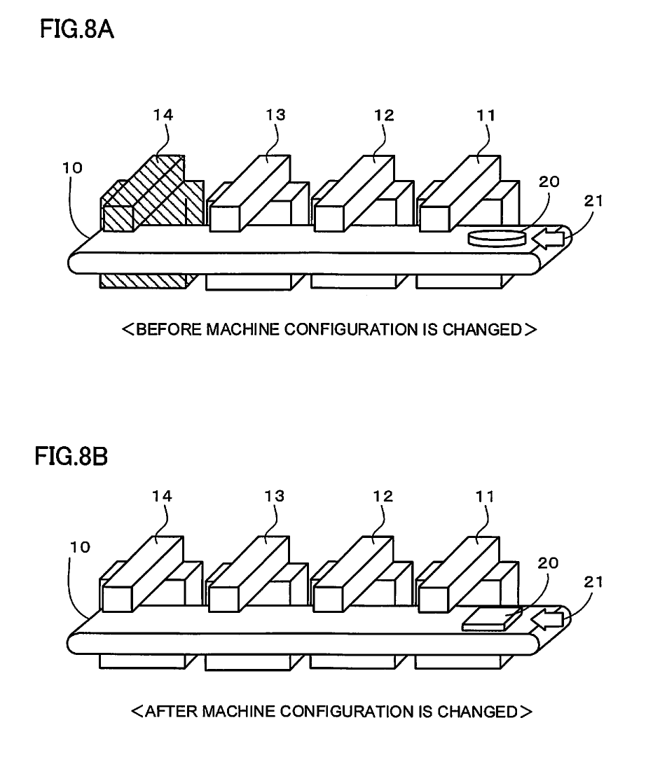

FIG. 8 shows an example illustrating a situation in which machining is performed while switching the system group whenever necessary in accordance with the target and including the one belt conveyor 10 and four imprinters 11, 12, 13, 14. When, as shown in FIG. 8A, the target is a circular workpiece, the fourth imprinter 14 is not needed, but when, as shown in FIG. 8B, the target is a rectangular workpiece, the fourth imprinter 14 needs to be used. In such a case, an operator changes the setting of the system group whenever necessary in accordance with the target and deals with the situation by excluding a fifth system (fourth imprinter 14) from the system group for a circular workpiece and including the fifth system (fourth imprinter 14) in the system group for a rectangular workpiece.

In this case, in a mode in which the parameter setting is manually changed to switch the system group, effort such as stopping the machine to reset parameters arises each time the system group is switched. The need to stop the machine is eliminated by switching the system group by signal control, leading to improvements in work efficiency. System group switching by a program command is similar to system group switching by signal control.

### [Target: Circular Workpiece]

System group: first to fourth systems

Master system: first system (belt conveyor)

Slave system: second to fourth systems (three imprinters)

### [Target: Rectangular Workpiece]

System group: first to fifth systems

Master system: first system (belt conveyor)

Slave system: second to fifth systems (four imprinters)

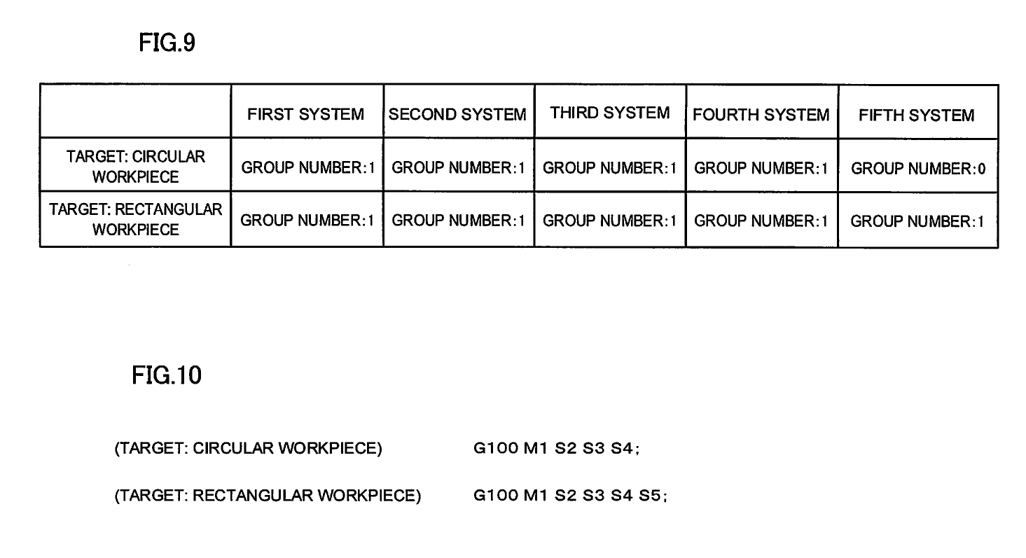

The system group setting and changes of the setting can be made, as shown in FIGS. 9 and 10, by a signal or a program.

[Signal] Set the group number of the system group (see FIG. 9).
[Program] Execute the system group setting command (see FIG. 10).

G100 as a system group change code is set as a command, the system number of the master system is set by the number subsequent to M, and the system number of the slave system is set by the number subsequent to S (see FIG. 10).

### Third Embodiment

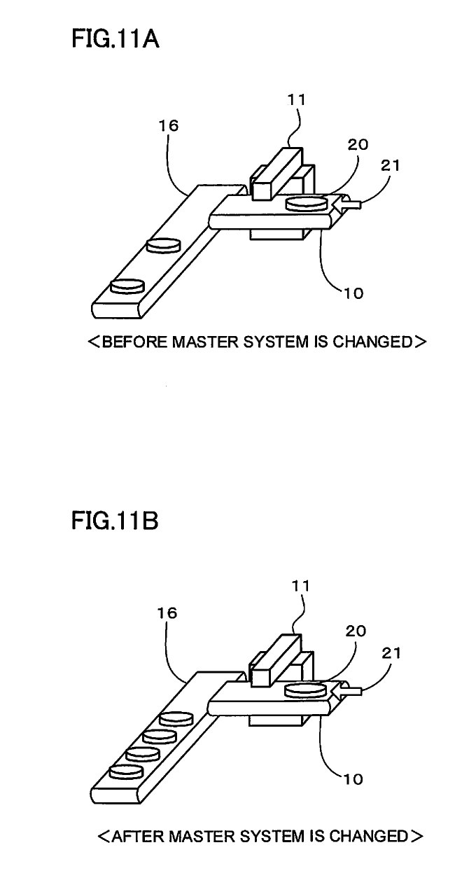

The master system may be changed in accordance with circumstances. For example, as shown in FIG. 11A, a system group is set by including the first belt conveyor 10 and the imprinter 11 and the belt conveyor 10 is set as the master system. Normally, a second belt conveyor 16 that transports the target 20 after imprinting does not need to be timed and is not included in the system group. However, if the target 20 continues to be sent from the first belt conveyor 10 when the second belt conveyor 16 for transportation halts, an excessive number of the targets 20 may be stored on the second belt conveyor 16, leading to collision. In such a case, by including the second belt conveyor 16 in the system group and setting the second belt conveyor 16 as the master system and the first belt conveyor 10 and the imprinter 11 as the slave systems when the second belt conveyor 16 begins to halt as shown in FIG. 11B, the collision of the targets 20 can be avoided by, when the second belt conveyor 16 stops or operates at low speed, the first belt conveyor 10 and the imprinter 11 also being stopped or operated at low speed.

In this case, there is no time to manually change parameter settings to switch the system group and the master system and thus, an automatic and swift switching operation can be implemented by monitoring and switching the second belt conveyor 16 by a signal.

### Fourth Embodiment

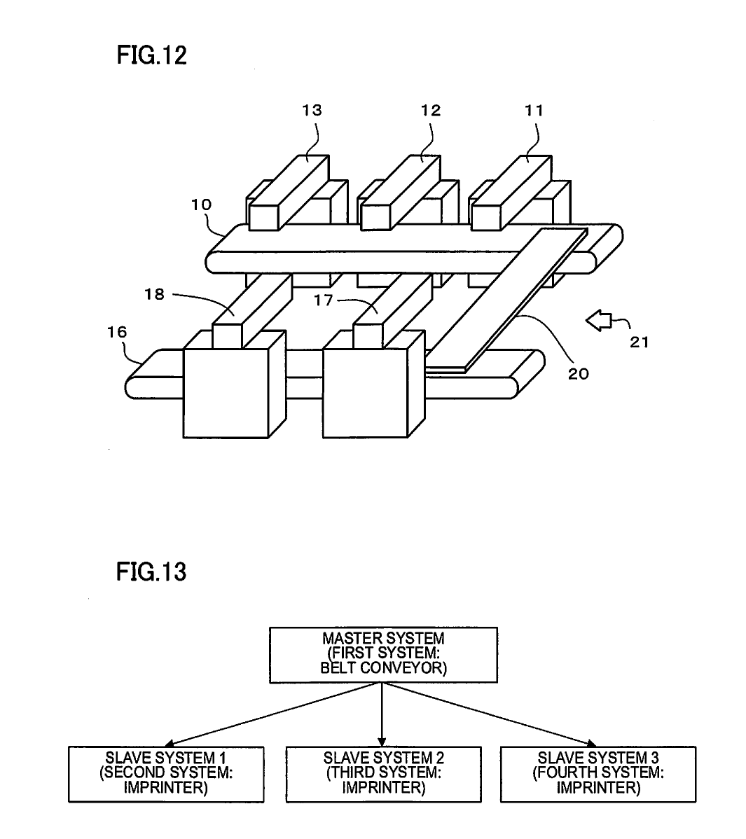

There are some cases when a plurality of system groups is integrated into one system group. In the machine configuration shown in the first embodiment described above, for example, a belt conveyor and three imprinters constitute a system group, but a system as shown in FIG. 12 that imprints both ends of a target in a long shape by a system group 1 (master system: first system, slave systems: second to fourth systems) on the back side and a system group 2 (master system: fifth system, slave systems: sixth and seventh systems) on the front side in synchronization is taken as an example.

In this case, there is a danger that the target 20 falls if the system group 1 and the system group 2 are not timed and thus, the system group 1 and the system group 2 need to be synchronized.

Thus, by selecting the master system from two master systems of the system groups 1, 2 and integrating the two master groups into one system group so that the fifth system is synchronized with the first system and as a result of synchronization, the sixth and seventh systems operate in synchronization, the central management by the master system at the hierarchically top level can be implemented and synchronization of timing can easily be implemented by the whole system group being controlled by following the timing of the top-level master system.

Hereinafter, the configuration of a system group will be described using the drawings.

By setting the master system from master systems, a hierarchical multiple structure of the master-slave can be implemented.

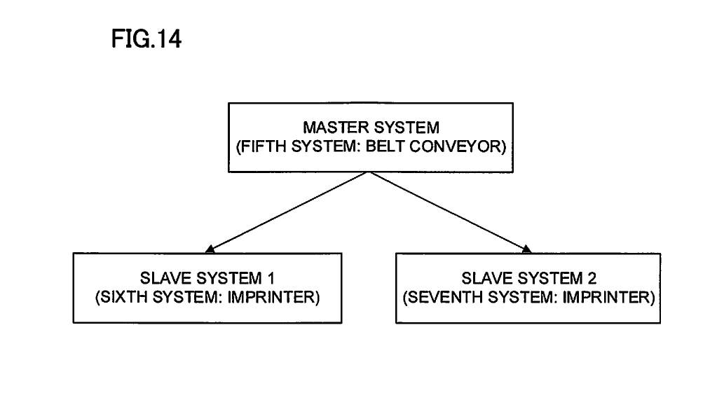

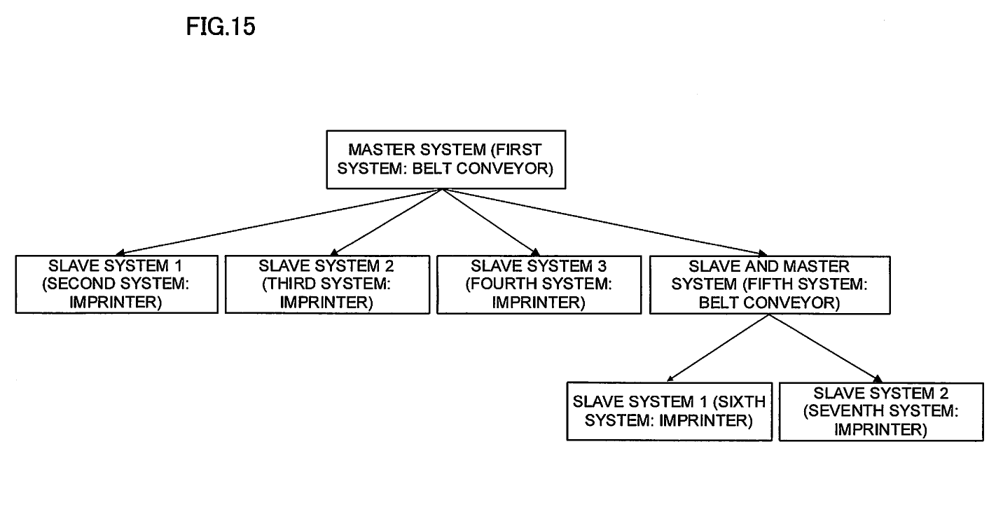

Original master group 1 (master group: first system, slave systems: second to fourth systems) (see FIG. 13)
Original master group 2 (master group: fifth system, slave systems: sixth and seventh systems) (see FIG. 14)
New system group (system group in a hierarchical multiple structure) (see FIG. 15)

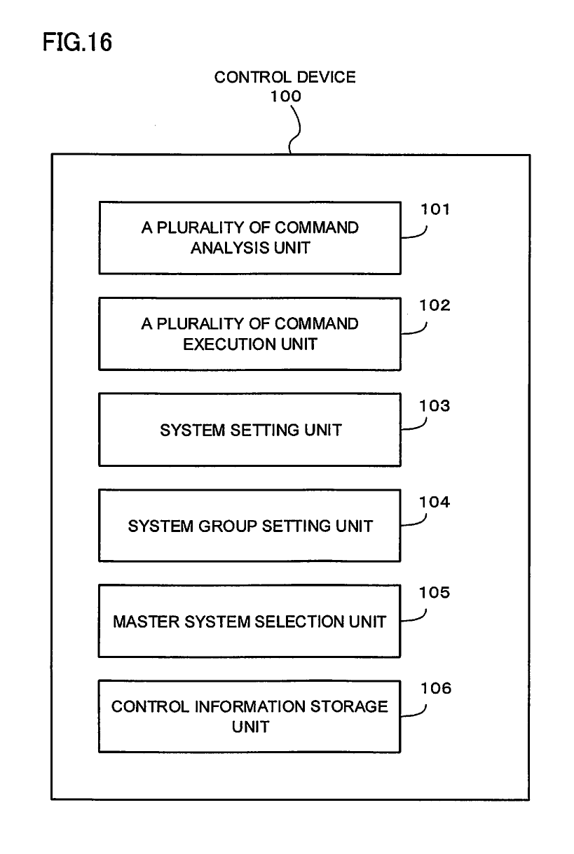

FIG. 16 is a functional block diagram of a control device according to the present invention. The control device 100 includes, as described above, a plurality of command analysis units 101 that analyze a program, a plurality of command execution units 102 that execute a command based on analysis results of the plurality of command analysis units 101, a system setting unit 103 that sets a system, a system group setting unit 104 that sets a system group, a master system selection unit 105 that selects a master system, and a control information storage unit 106 that stores master control information.

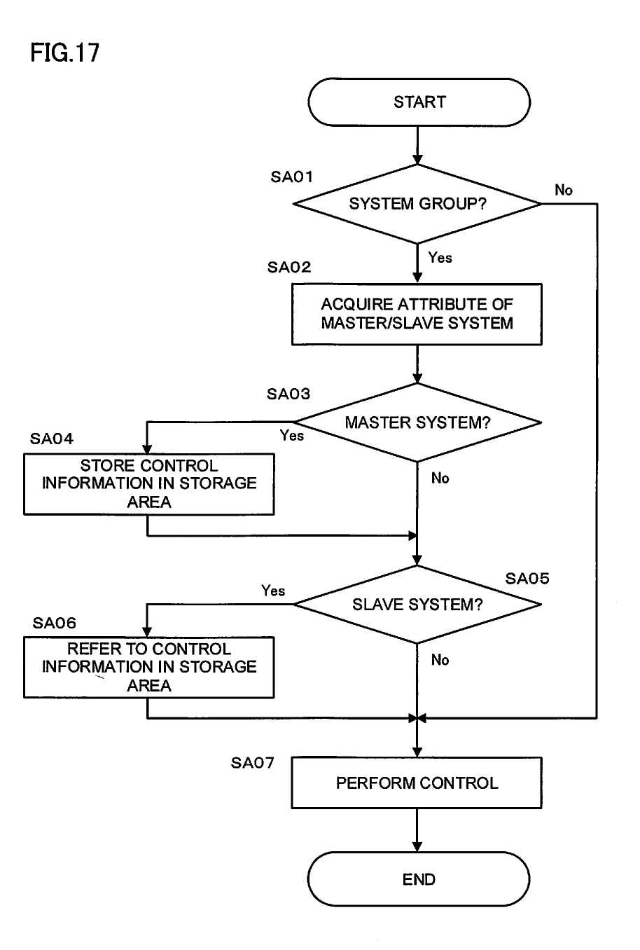

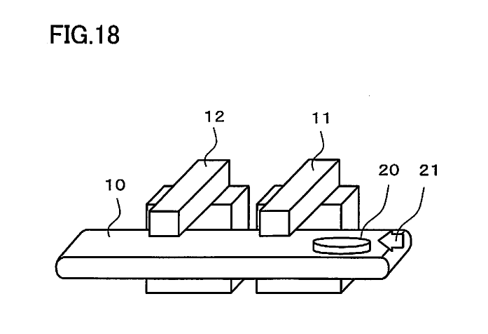

FIG. 17 is a diagram illustrating the flow of control. When normal control is started, if a system belongs to a system group, an attribute showing whether the system is a master system or a slave system is acquired. If the system is a master system, control information is stored in a storage area corresponding to the system group number. If the system is a slave system, control information of the master system stored in the storage area corresponding to the system group number is referred to for control.

Hereinafter, each step will be described.

[Step SA01] When control is started, first check whether a system belongs to a system group and if the system does not belong the system group (NO), proceed to step SA07 and if the system belongs to the system group (YES), proceed to step SA02.
[Step SA02] Acquire attribute data specifying whether each system is a master system or a slave system.
[Step SA03] Determine whether the system is a master system and if the system is a master system (YES), proceed to step SA04 and if the system is not a master system (NO), proceed to step SA05.
[Step SA04] Store control information on the storage area and proceed to step SA05.
[Step SA05] Determine whether the system is a slave system and if the system is a slave system (YES), proceed to step SA06 and if the system is not a slave system (NO), proceed to step SA07.
[Step SA06] Refer to control information in the storage area.
[Step SA07] Perform the control and terminate the steps.

As described above, even if a system is controlled by a plurality of systems or a plurality of sequence programs, a cooperative operation can be performed by a control device according to the present invention without using cooperative processing between sequence programs.

In the foregoing, the embodiments of the present invention have been described, but the present invention is not limited to the above embodiments and can be carried out in other embodiments by making appropriate changes.

1. A control device including a plurality of command analysis units that control a machine having a plurality of axes driven by a motor, a plurality of command execution units that execute a command analyzed by the command analysis units, and a system setting unit that sets by dividing the plurality of axes into a plurality of systems, wherein one axis or a plurality of axes controlled by one program of the plurality of axes is set as one system, to control the plurality of systems, the control device comprising:
a system group setting unit that sets two systems or more selected from the plurality of systems as one system group based on a parameter setting;
a master system selection unit that selects one system from the system group as a master system to be a reference of operation and classifies other systems of the system group as a slave system group based on a parameter setting;
a control information storage unit that stores the program needed for control of the master system and control data including a signal and a parameter related to the control of the program as master control information; and
a synchronization unit that controls the operation of the slave system group so as to be synchronized with the operation of the master system by referring to a program command, a control signal, and a control parameter stored as the master control information for the control of the slave system group.

2. The control device according to claim 1, wherein the system group setting unit is a unit that sets or changes the system group in any timing based on signal control or the command of the program.

3. The control device according to claim 1, wherein the master system selection unit is a unit that sets or changes the master system in any timing based on the signal control or the command of the program.

4. The control device according to claim 1, wherein the master system selection unit forms a master-slave hierarchical multiple structure by selecting the master system from a plurality of the master systems.
